(19) United States
(12) Patent Application Publication
(10) Pub. No.: US 2025/0133255 A1
(43) Pub. Date: Apr. 24, 2025

(54) SYSTEMS AND METHODS FOR A MEDIA PLATFORM

(71) Applicant: John C. LABRECHE, Palos Verdes Estates, CA (US)

(72) Inventor: John C. LABRECHE, Palos Verdes Estates, CA (US)

(21) Appl. No.: 18/493,060

(22) Filed: Oct. 24, 2023

(51) Int. Cl. H04N 21/2668; G06F 16/955; G06K 19/06; H04N 21/431

(52) U.S. Cl. CPC H04N 21/2668; G06F 16/9554; G06K 19/06037; H04N 21/431

(57) ABSTRACT

Disclosed are systems and methods that provide a computerized framework for securely enabling access to media content of an event, whereby such access can enable a viewing user to view, edit and/or curate the content according to their specific interests. The disclosed framework can enable, upon interaction with a QR code on a wearable item associated with the event, for example, secure access via a network resource to curate content from the event. The content can be downloadable, editable and/or streamed, and can be personalized for the user via artificial intelligence/machine learning (AI/ML) analysis of the user and/or event information, so as to provide a customized, personal rendering experience for the viewing user.

### FIELD OF THE DISCLOSURE

The present disclosure is generally related to a media/content hosting and providing platform, and more particularly, to a computerized framework for securely enabling personalized media to be generated and/or shared via a network media platform.

### BACKGROUND

Currently, mechanisms for accessing content are tied to available media from professional entities (e.g., news media, such as, for example, ESPN®) or professional or amateur social sites (e.g., a witness user that uploads captured video to their Instagram® page, for example).

### SUMMARY OF THE DISCLOSURE

This, however, has many drawbacks. That is, content is generally not personalized, nor are the mechanisms that are in place for providing specifically sought after content easily accessible and customized for specific events for which the content is generated and/or associated.

For example, if a user attends an amateur athletic union (AAU) volleyball game, such games are traditionally videotaped for later viewership. If the user desires to watch the footage from the game or watch only portions that pertain to a specific player, then that user must search for and locate the content via traditional means, and then curate the content on their end to match their desired rendering experience. For example, the user can search social media accounts associated with sponsors of the AAU event and/or teams participating in the event, and then manually filter down the content to meet their needs.

Such static mechanisms for curating personalized content, as well as accessing desired content is being outpaced by the technologies that host and/or avail such users to the content. Thus, as discussed herein, the disclosed systems and methods provide a novel computerized framework that enables content to be tied directly to items (e.g., merchandise) from an event, whereby upon interaction with a quick response (QR) code affixed or associated with the item, the user can automatically and seamlessly be provided access to the desired content.

According to some embodiments, while the discussion herein may focus on the usage of a QR code, it should not be construed as limiting, as one of skill in the art would readily understand that any type of known or to be known scannable text, image or character string, such as, but not limited to, a NFC tag, barcode, SnapTag™, image recognition, Bluetooth beacons, and the like, can be utilized without departing from the scope of the instant disclosure.

In some embodiments, as discussed below in more detail, upon being provided secure access to the content, the user can edit, modify and/or be provided read/write access so as to curate any form of media. In some embodiments, the access to the content can be in the form of, but not limited to, time-restricted, location restricted, streaming (e.g., stream a live event), personalized (e.g., view certain plays or actions by a player, for example), and the like, or some combination thereof.

Accordingly, while the discussion herein may focus on an event corresponding to a sporting event, it should not be construed as limiting, as any event, whether a real-world event (e.g., news broadcast, play, interview, and the like), pre-recorded event (e.g., movie, television show, podcast, and the like) and/or digital event (e.g., augmented reality/virtual reality (AR/VR) content, video game play, metaverse performance/actions, and the like) can be utilized as the source of the accessed and curated media without departing from the scope of the instant disclosure. Moreover, while the content discussed herein may be focused on video files, items and/or content, it should not be construed as limiting, as any type of content can be securely held, streamed and/or accessible via the disclosed systems and methods without departing from the scope of the instant disclosure—for example, text, audio, video, multi-media, AR/VR, and the like, or some combination thereof.

According to some embodiments, a method is disclosed for securely enabling personalized media to be accessed, generated and/or shared via a network media platform. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for securely enabling personalized media to be accessed, generated and/or shared via a network media platform.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 depicts non-limiting examples according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

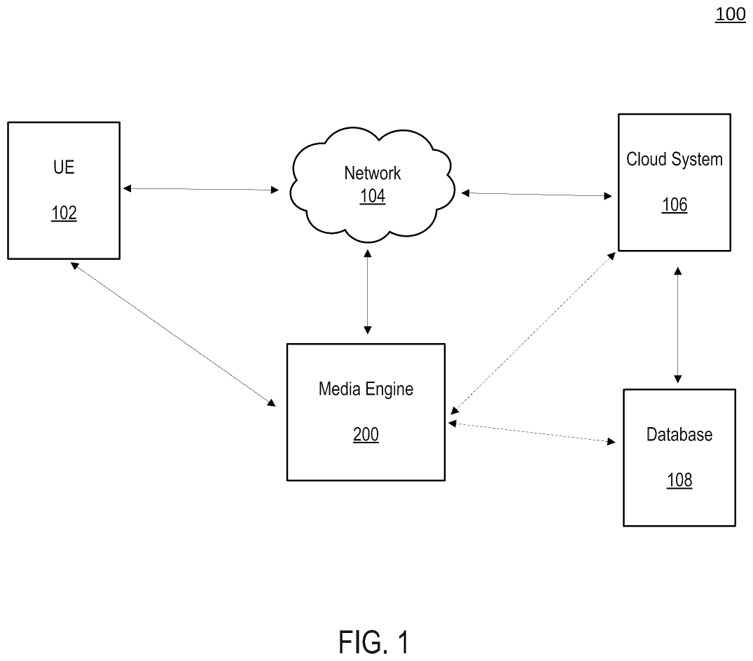

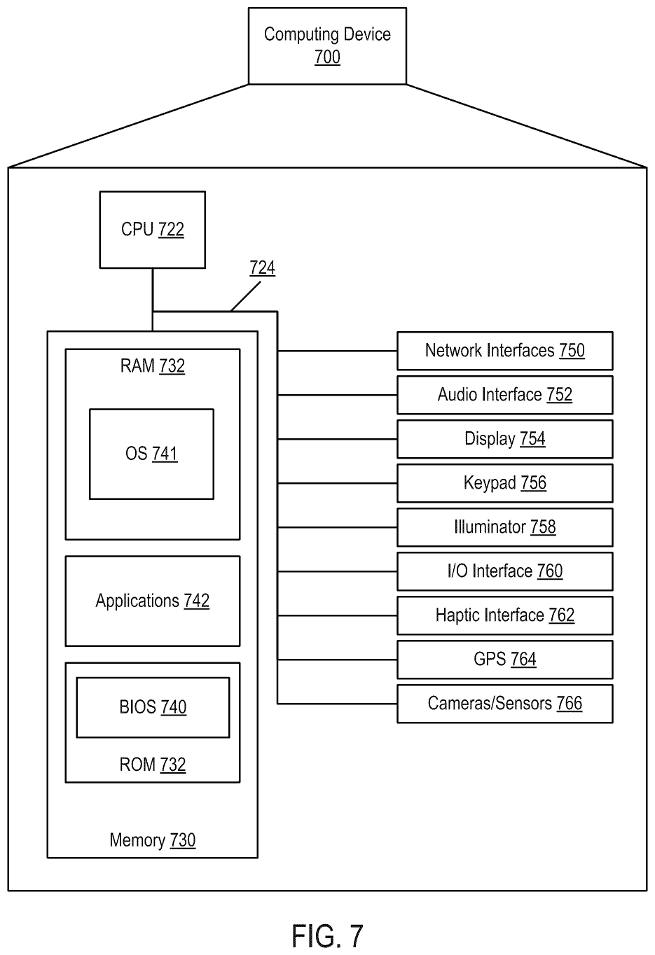

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 7), network 104, cloud system 106, database 108 and media engine 200. It should be understood that while system 100 is depicted as including such components, it should not be construed as limiting, as one of ordinary skill in the art would readily understand that varying numbers of UEs, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, game console, Internet of Things (IoT) device, wearable device, autonomous machine, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be associated with network platform, network resource and/or network location from where services and/or applications may be accessed, sourced or executed from. For example, system 106 can represent the cloud-based architecture associated with a web page/portal, which has associated network resources hosted on the internet or private network (e.g., network 104), which enables (via engine 200) the media management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, and the services and applications provided by cloud system 106 and/or media engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

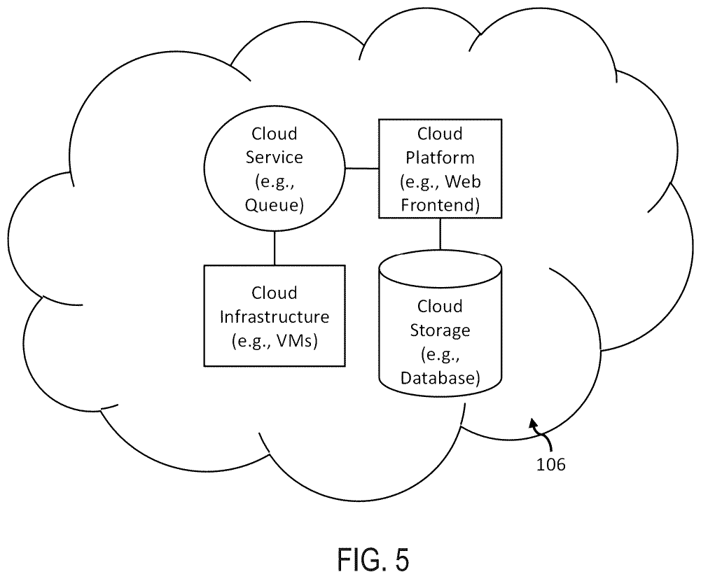

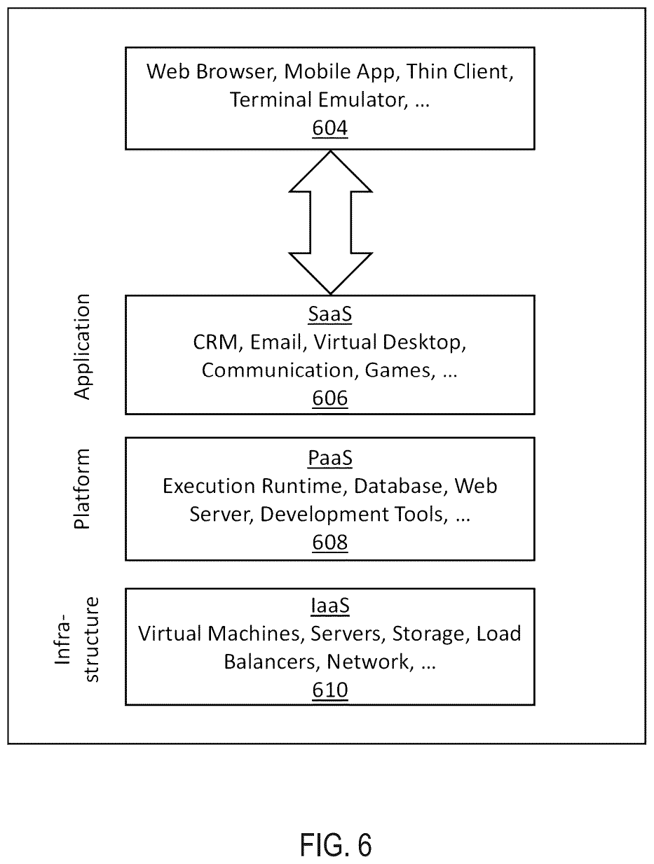

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Media engine 200, as discussed above and further below in more detail, can include components for the disclosed functionality. According to some embodiments, media engine 200 may be a special purpose machine or processor, and can be hosted by a device on network 104, within cloud system 106 and/or on UE 102. In some embodiments, engine 200 may be hosted by a server and/or set of servers associated with cloud system 106.

According to some embodiments, as discussed in more detail below, media engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, media engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 and/or devices over network 104 from cloud system 106. In some embodiments, engine 200 may be configured and/or installed as an augmenting script, program or application (e.g., a plug-in or extension) to another application or program provided by cloud system 106 and/or executing on UE 102.

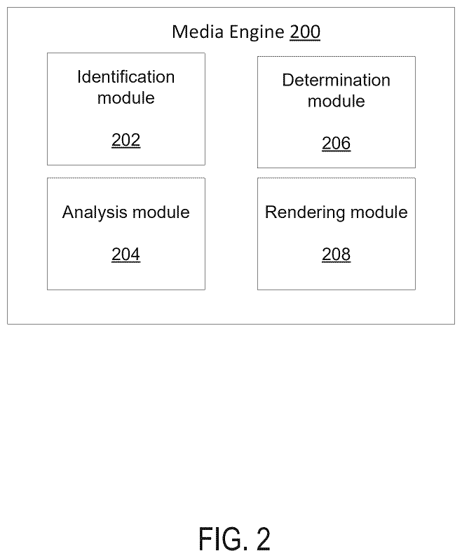

As illustrated in FIG. 2, according to some embodiments, media engine 200 includes identification module 202, analysis module 204, determination module 206 and rendering module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

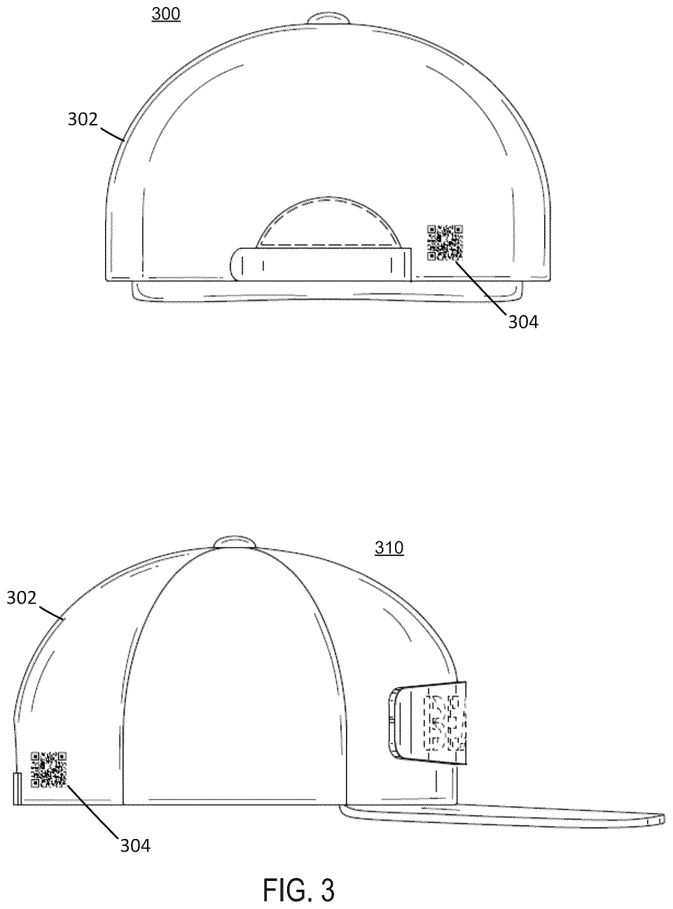

Turning to FIG. 3, example embodiments 300 and 310 provide views of a wearable item 302 which can have affixed therein a QR code 304. It should be understood that while the wearable item is depicted as a hat, it should not be construed as limiting, as the item 302 can take the form of any type of object for which a scannable code can be affixed therein, for example, but not limited to, boots, shirts, sunglasses, balls, and the like. Indeed, in some embodiments, the item 302 can take the form of a digital item, such as a user interface (UI) displayed on UE 102, whereby the UI corresponds to an electronic message and/or web page, for example.

According to some embodiments, while the QR code 304 is depicted on the back side of the wearable item 302, its should not be construed as limiting, as it should be readily understood that the QR code 304 can be positioned on any portion of item 302 without limiting how the QR code can be interacted with by UE 102 to capture the network location represented by the QR code 304.

By way of a non-limiting example, according to some embodiments and discussed in more detail below, a user can visit a concert and purchase a hat from the concert, where the hat 302 includes a QR code 304. Upon the user scanning the QR code 304 via their smart phone (e.g., UE 102, as discussed supra), a web page UI associated with the concert from which concert footage can be accessed. According to some embodiments, the disclosed framework can leverage information related to the user to determine that the user has a favorite song of the artist. Therefore, such information can be leveraged upon the scanning of the QR code 304, whereby when the UI is displayed on the user's device, concert footage for the favorite song can be displayed.

As discussed below, the concert footage availed to the user and the user's device can be edited and/or modified to correspond to requested input from the user. And, as discussed below, in some embodiments, the user can stream the entirety (or portion) of the concert, which can be in an on-demand format or live-streamed format.

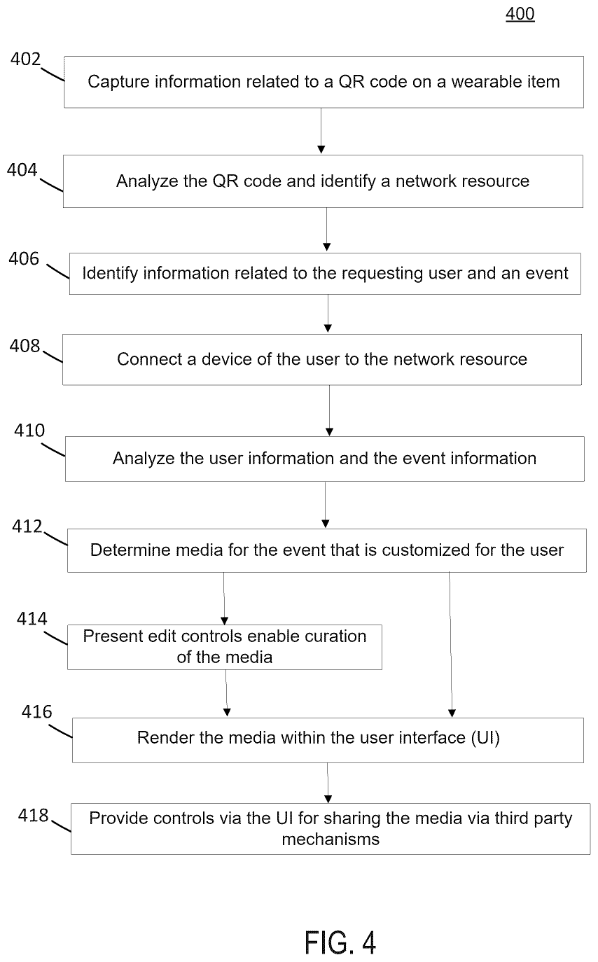

Turning to FIG. 4, Process 400 provides non-limiting example embodiments for the disclosed media management framework. According to some embodiments, Process 400 provides the executable steps for securely enabling access to media content of an event, whereby such access can enable a viewing user to view, edit and/or curate the content according to their specific interests. As provided below, Process 400 can enable, upon interaction with a QR code on a wearable item associated with the event, for example, secure access via a network resource to curate content from the event. The content can be downloadable, editable and/or streamed, and can be personalized for the user via AI/ML analysis of the user and/or event information, so as to provide a customized, personal rendering experience for the viewing user.

According to some embodiments, Step 402 of Process 400 can be performed by identification module 202 of media engine 200; Steps 404 and 410 can be performed by analysis module 204; Steps 406 and 412 can be performed by determination module 206; and Steps 408 and 414-418 can be performed by rendering module 208.

According to some embodiments, Process 400 begins with Step 402 where a UE (e.g., user smart phone, as discussed above at least in relation to UE 102 in FIG. 1 and below at least in relation to client device 700 in FIG. 7) can perform an image capture operation to scan a QR code on a wearable item. For example, with reference to FIG. 3, discussed supra, a user can utilize the camera on their smart phone to scan the QR code 304 on hat 302.

In Step 404, based on the scanning, the QR code can be analyzed and the corresponding network resource represented by the QR code can be identified. In some embodiments, the QR code comprises a digital representation of a network location of the network resource. For example, a web address for which event-based content is accessible on-demand or via a live-stream can be identified.

In Step 406, engine 200 can determine, derive, extract, retrieve or otherwise identify information related to a user (and/or the device/UE) and the event. According to some embodiments, the user information can correspond to a profile and/or account, and include, but is not limited to, an identifier (ID), demographic data, biometric data, behavior data (e.g., preferences for certain types of media over the past n days, for example), user preferences and/or interests, device ID, location, and the like, or some combination thereof. In some embodiments, the user information can be derived from a profile associated with the network resource, or a third party network resource profile/account of the user.

In some embodiments, the event information can correspond to, but not be limited to, a time, date, frequency, location, type of event, participants, winner, seeding, items available at the event (e.g., item 302, for example), sponsors of the event, and the like or some combination thereof.

According to some embodiments, engine 200 can collect data related to the capture (of Step 402), network resource (from Step 404), the user, the event, and the like, and determine the user and/or event information based therefrom. In some embodiments, such information identification can involve compiling the data into a data structure, parsing the data structure, and extracting the user and/or event information based therefrom. In some embodiments, such information can be derived from and/or stored in database 108, as discussed above.

In Step 408, the device is connected to the network resource. For example, as discussed above, such connection can involve displaying a web page (identified from the QR code) for an event, where the wearable item from which the QR code was scanned pertains to such event, as discussed above. As discussed below, such connection can enable the user access to the event content and/or curated media, discussed infra. In some embodiments, a user may need to provide login credentials to access the network resource and/or view the associated UI (e.g., username/password, biometrics, PIN, and the like).

In Steps 410-412, engine 200 can determine a context for which a display page (or UI) of the network resource can be displayed for the user. The context can enable an automatic determination as to (or compilation of) what type, version, format, quality and/or quality of the content is provided for viewing (as in Step 416).

According to some embodiments, in Step 410, engine 200 can analyze the user information and event information compiled in Step 406. According to some embodiments, engine 200 can implement any type of known or to be known computational analysis technique, algorithm, mechanism or technology to perform such analysis.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the collected information, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 412, based on the analysis from Step 412, engine 200 can determine the context for the user, for which media for the event can be customized therefrom. In some embodiments, Step 412 can involve leveraging the determined context, such that the content for the event can be identified and modified into a version for display within the UI in accordance with the user's context.

For example, if the user desires to view footage from a basketball tournament, and is determined to be a father of one of the participants, engine 200 can leverage such understanding to predict that the user only wants to view footage of his son. Therefore, in Step 412, engine 200 can curate specified media for the father user by creating a new version of the content that only includes highlights for the father's son. In some embodiments, such new version can be a new media file that has been created.

In another non-limiting example, if the user is an scout, and the basketball tournament is an AAU tournament for high school players at the Nike® camp, then the footage of the camp can be curated to track certain players depicted actions, which can be sequentially organized into portions for each respective player. Such examples can evidence engine 200 utilizing computer vision and image recognition analysis to identify and extract media from the content that corresponds to particular people depicted in the captured footage content.

In some embodiments, in Step 414, edit controls can be presented for display within the page/UI displayed on the user's device. In some embodiments, such edit controls can enable personalized editing of the content by the user, which can be used to edit the curated media from Step 412 and/or the original footage, which can also be provided for editing by the user.

In Step 416, engine 200 can cause the rendering of the curated/personalized media, which as discussed above, can be the created media (from Step 412 and/or 414) and/or the original footage of the event.

According to some embodiments, when the media being rendered is a live stream, processing of the steps of Process 400 can involve engine 200 determining such context (from Step 412) and proceeding from Step 412 to Step 416, where the controls provided in Step 414 can correlate to playback controls (pause, rewind, stop, play, and the like). In some embodiments, such controls (from Step 414) can enable the creation of highlight reels or clips for particular plays and/or actions from the footage, which can be performed in a similar manner as discussed above.

Accordingly, in some embodiments, in Step 418, engine 200 can cause modifications to the UI which can enable additional controls for the sharing of the media, which can be via mechanisms available from within the portal of the network resource and/or via third party mechanisms (e.g., email, social media posting, SMS messaging, MMS messaging, and/or any other type of communication platform). In some embodiments, such controls can also include capabilities for locally storing the media.

Thus, rather than searching for content on the internet, or scouring social media sites for clips and/or highlights of events, the disclosed systems and methods provide novel mechanisms for accessing media content of an event, whereby such access can enable a viewing user to view, edit and/or receive curations of the content according to their specific interests.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
identifying information related to a network resource, the network resource comprising content related to an event;
determining information related to a user and the event, the user information and event information being determined based upon the identification of the network resource information;
determining, based on the user information and event information, a context for the user, the context comprising an indication as to a desired form of the content and an indication of a relationship of the user to at least a portion of what is depicted in the content;
creating media for the event from the content related to the event, the media being a new version of the content that comprises a portion of the content that pertains to the determined context of the user, the media being in the desired form of the content; and
rendering, over a network, for display on a user device, a user interface (UI) of the network resource, the UI comprising functionality for rendering the created media.

2. The method of claim 1, further comprising:
identifying, from a database, the content related to the event;
analyzing, based on the determined context, the content; and
modifying, based on the analysis, the content, wherein, the created media is based on the modified content.

3. The method of claim 1, further comprising:
generating and presenting, within the UI, a set of controls, the set of controls enable modifications to the created media.

4. The method of claim 1, further comprising:
generating and presenting, within the UI, a set of controls, the set of controls enable sharing of the media via a communication platform.

5. The method of claim 1, wherein the identification of the network resource information is resultant from the user device scanning a code associated with an item, the item being a real-world object associated with the event.

6. The method of claim 5, wherein the item is wearable merchandise from the event.

7. The method of claim 5, wherein the code is a quick response (QR) code comprising a digital representation of a network location of the network resource.

8. The method of claim 1, wherein the event is a current event, wherein the content is a live-stream of the event, wherein the rendering of the UI includes the rendering of the live-stream.

9. The method of claim 1, wherein the determination of the context is performed via execution of an artificial intelligence and/or machine learning algorithm.

10. The method of claim 1, wherein the network resource is a web page.

11. A device comprising:
a processor configured to:
identify information related to a network resource, the network resource comprising content related to an event;
determine information related to a user and the event, the user information and event information being determined based upon the identification of the network resource information;
determine, based on the user information and event information, a context for the user, the context comprising an indication as to a desired form of the content and an indication of a relationship of the user to at least a portion of what is depicted in the content;
create media for the event from the content related to the event, the media being a new version of the content that comprises a portion of the content that pertains to the determined context of the user, the media being in the desired form of the content; and
render, over a network, for display on a user device, a user interface (UI) of the network resource, the UI comprising functionality for rendering the created media.

12. The device of claim 11, wherein the processor is further configured to:
identify, from a databased, the content related to the event;
analyze, based on the determined context, the content; and
modify, based on the analysis, the content, wherein, the created media is based on the modified content.

13. The device of claim 11, wherein the processor is further configured to:
generate and present, within the UI, a set of controls, the set of controls enable modifications to the created media; and
generate and present, within the UI, another set of controls, the other set of controls enable sharing of the media via a communication platform.

14. The device of claim 11, wherein the identification of the network resource information is resultant from the user device scanning a quick response (QR) code associated with an item, the item being a real-world object associated with the event.

15. The device of claim 11, wherein the event is a current event, wherein the content is a live-stream of the event, wherein the rendering of the UI includes the rendering of the live-stream.

16. A non-transitory computer-readable storage medium tangibly encoded with computer-executable instructions that when executed by a processor, perform a method comprising:
identifying information related to a network resource, the network resource comprising content related to an event;
determining information related to a user information and the event, the user and event information being determined based upon the identification of the network resource information;
determining, based on the user information and event information, a context for the user, the context comprising a portion of the content that pertains to the user, the media being in an indication as to a desired form of the content and an indication of a relationship of the user to at least a portion of what is depicted in the content;
creating media for the event from the content related to the event, the media being a new version of the content that comprises a portion of the content that pertains to the determined context of the user, the media being in the desired form of the content; and
rendering, over a network, for display on a user device, a user interface (UI) of the network resource, the UI comprising functionality for rendering the created media.

17. The non-transitory computer-readable storage medium of claim 16, further comprising:
identifying, from a databased, the content related to the event;
analyzing, based on the determined context, the content; and
modifying, based on the analysis, the content, wherein, the created media is based on the modified content.

18. The non-transitory computer-readable storage medium of claim 16, further comprising:
generating and presenting, within the UI, a set of controls, the set of controls enable modifications to the created media; and
generating and presenting, within the UI, another set of controls, the other set of controls enable sharing of the media via a communication platform.

19. The non-transitory computer-readable storage medium of claim 16, wherein the identification of the network resource information is resultant from the user device scanning a quick response (QR) code associated with an item, the item being a real-world object associated with the event.

20. The non-transitory computer-readable storage medium of claim 16, wherein the event is a current event, wherein the content is a live-stream of the event, wherein the rendering of the UI includes the rendering of the live-stream.
